(19) United States
(12) Patent Application Publication
(10) Pub. No.: US 2011/0282546 A1
(43) Pub. Date: Nov. 17, 2011

(54) APPARATUS AND METHOD FOR IDENTIFYING TIRE PRESSURE SENSOR MODULE

(75) Inventors: Sung Joon HEO, Seoul (KR); Ji Hyun JUNG, Gyeonggi-do (KR)

(73) Assignee: MANDO CORPORATION

(21) Appl. No.: 13/107,406

(22) Filed: May 13, 2011

(30) Foreign Application Priority Data
May 13, 2010 (KR) 10-2010-0044782

(51) Int. Cl. G06F 7/00; G06F 15/00

(52) U.S. Cl. 701/36; 702/150

(57) ABSTRACT

Disclosed are an apparatus and a method for identifying a plurality of tire pressure sensor modules. Data wirelessly transmitted from the tire pressure sensor modules are received by using a signal cable connected between a wheel speed sensor module and a control module. The control module identifies the pressure sensor modules mounted on vehicle tires according to the intensities of received signals.

This application claims the benefit of Korean Patent Application No. 10-2010-0044782 filed on May 13, 2010, in the Korean Intellectual Property Office, the disclosure of which is incorporated herein by reference.

### BACKGROUND

1. Field

The disclosure relates to an apparatus and a method for identifying a plurality of tire pressure sensor modules to detect the pressure of vehicle tires.

2. Description of the Related Art

In general, an ESP (Electronic Stability Program) system optimally controls the driving attitude of a vehicle by integrally controlling the braking force and the speed of the vehicle, so that the vehicle can be stably driven on a slippery road as well as a plane road.

A vehicle having the ESP is equipped with a TPMS (Tire Pressure Monitoring System) that detects a tire pressure to inform a driver of the tire pressure. In other words, tire pressure sensor modules including pressure sensors, which detect the air pressure of tires, are provided in the tires, and, if the tire pressure measured through the tire pressure sensor modules is abnormal, this abnormal state of the tire pressure is informed to the driver.

In order to detect the tire pressure, signals are transferred between the tire pressure sensor module provided in the tire and a control module installed on a vehicle chassis through a wireless manner. In other words, signals transmitted from the tire pressure sensor modules are supplied to the control module through an antenna.

If tire pressure sensor modules are mounted on every vehicle tires, the procedure of identifying the tire pressure sensor modules may be performed. According to the related art, a signal transmitter is additionally used to individually transmit an indication signal for sensor operation to the tire pressure sensor module. If the response of the tire pressure sensor module is confirmed, the tire module sensor module may be identified. As described above, since the signal transmitter needs to be provided corresponding to each tire pressure sensor module, the number of the working processes is increased, and economical burden is caused.

### SUMMARY

Accordingly, it is an aspect of the disclosure to identify a plurality of tire pressure sensor modules mounted on vehicle tires according to signal intensities received through a signal cable connected to a wheel speed sensor.

Additional aspects and/or advantages of the disclosure will be set forth in part in the description which follows and, in part, will be apparent from the description, or may be learned by practice of the disclosure.

The foregoing and/or other aspects of the disclosure are achieved by a tire pressure sensor module identifying apparatus including a plurality of tire pressure sensor modules mounted on tires of a vehicle to wirelessly transmit pressures of the tires, a plurality of signal cables installed corresponding to the tire pressure sensor modules and electrically connected to electrical parts except for the tire pressure sensor modules to receive signals from the tire pressure sensor modules, a signal intensity measuring unit to measure intensities of signals received therein from the tire pressure sensor modules through at least one of the signal cables, a plurality of switches connected between the signal cables and the signal intensity measuring unit and selectively turned on or turned off, and a control module to turn on one of the switches, compare the intensities of the signals received from the tire pressure sensor modules through the signal cable connected to the one switch, and identify a position of the tire pressure sensor module representing a highest signal intensity based on a position of the switch.

The tire pressure sensor module identifying apparatus further includes a memory storing an identifier of the tire pressure sensor module representing the highest signal intensity and the position of the tire pressure sensor module representing the highest signal intensity.

The signal cables include power lines.

Each power line is used to supply power to a wheel speed sensor.

Each signal cable has one end connected to a wheel speed sensor to transfer a signal of the wheel speed sensor.

The control module sequentially turns on the switches to identify positions of the tire pressure sensor modules.

According to another aspect of the disclosure is achieved by a tire pressure sensor module identifying method including turning on one of switches of signal cables provided around a plurality of tire pressure sensor modules, receiving and measuring signals transmitted from the tire pressure sensor modules through the signal cable connected to the switch, comparing intensities of the measured signals of the tire pressure sensor modules with each other, determining the tire pressure sensor module representing a highest signal intensity, and identifying a position of the determined tire pressure sensor module based on a position of the switch.

The receiving the signals from the tire pressure sensor modules includes receiving identifiers of the tire pressure sensor modules.

The tire pressure sensor module identifying method further includes storing the identifier of the tire pressure sensor module representing the highest signal intensity together with the position of the tire pressure sensor module while corresponding to the identifier.

The tire pressure sensor module identifying method further includes previously storing information about positions of the switches of the signal cables provided around the tire pressure sensor modules.

As described above, according to the disclosure, the tire pressure sensor module identifying apparatus according to the embodiment can receive data wirelessly transmitted from the tire pressure sensor modules by using the signal cable connecting the wheel speed sensor and the control module, and easily identify the position of the tire pressure sensor modules, which are mounted on vehicle tires, according to the intensities of the received signals.

### BRIEF DESCRIPTION OF THE DRAWINGS

These and/or other aspects and advantages of the disclosure will become apparent and more readily appreciated from the following description of the embodiments, taken in conjunction with the accompanying drawings of which:

FIG. 1 is a control block diagram showing an apparatus for identifying a tire pressure sensor module according to the embodiment of the disclosure;

FIG. 2 is a detailed block diagram showing a main component of FIG. 1;

FIG. 3 is a table showing the operation of identifying sensor IDs corresponding to the measurement of signal intensities according to the disclosure; and

FIG. 4 is a flowchart showing the operation of the apparatus for identifying the tire pressure sensor module according to the disclosure.

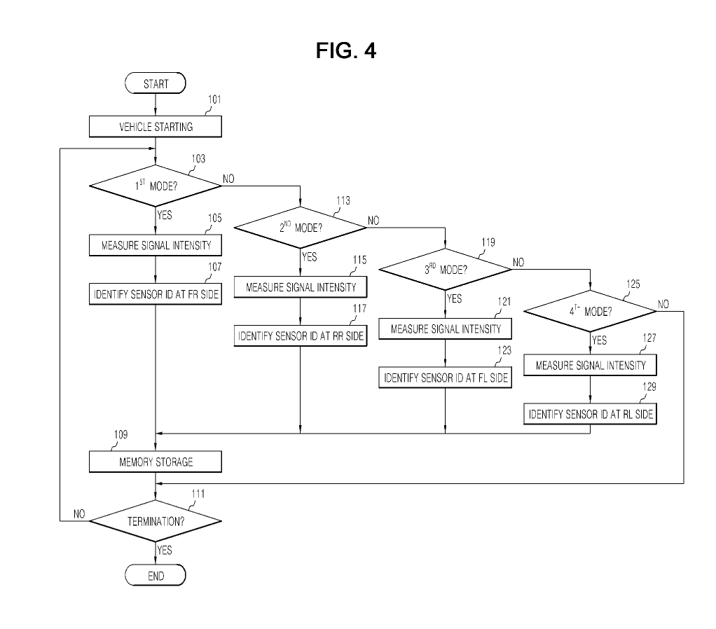

### DETAILED DESCRIPTION OF THE EXEMPLARY EMBODIMENTS

Reference will now be made in detail to the embodiments of the disclosure, examples of which are illustrated in the accompanying drawings, wherein like reference numerals refer to the like elements. The embodiments are described below to explain the disclosure by referring to the figures.

Hereinafter, an exemplary embodiment of the disclosure will be described.

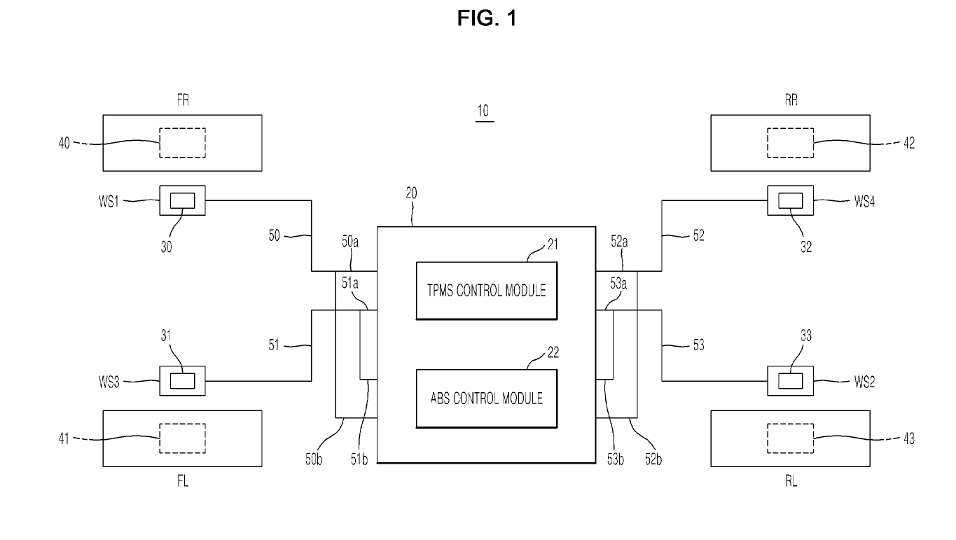

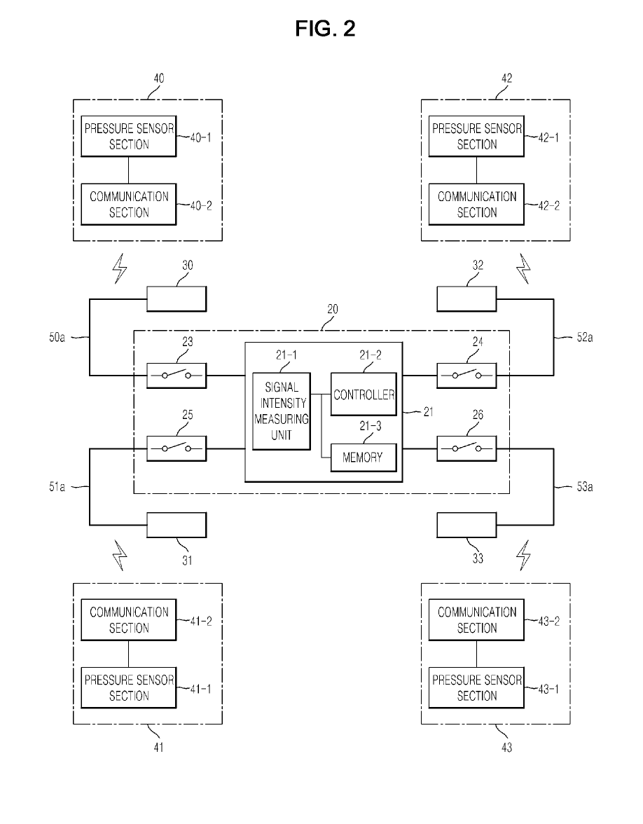

FIG. 1 is a control block diagram showing an apparatus 10 for identifying a tire pressure sensor module according to the embodiment of the disclosure; and FIG. 2 is a detailed block diagram showing a main component of FIG. 1.

As shown in FIGS. 1 and 2, the apparatus 10 for identifying a tire pressure sensor module includes a plurality of tire pressure sensor modules 40, 41, 42, and 43 provided in tires FL, FR, RL, and RR to measure the pressures of the related tires and to wirelessly transmit the measured pressures.

The tire pressure sensor modules 40, 41, 42, and 43 include pressure sensor sections 40-1, 41-1, 42-1, and 43-1, which detect the pressures of the related tires, and communication sections 40-2, 42-1, 42-2, and 43-2, which wirelessly transmit the pressures of the related tires, respectively. The tire pressure sensor modules 40, 41, 42, and 43 are provided therein with a battery, which is not shown, so that the tire pressure sensor modules 40, 41, 42, and 43 can be driven through self-generated power. Accordingly, the tire pressure sensor modules 40, 41, 42, and 43 can transmit the pressures of the tires regardless of the starting of the vehicle.

In this case, the tire pressure sensor modules 40, 41, 42, and 43 wirelessly transmit the measured tire pressures together with sensor IDs thereof. Simultaneously, the tire pressure sensor modules 40, 41, 42, and 43 may wirelessly transmit tire temperatures measured by using temperature sensors that are not shown.

A plurality of wheel speed sensor modules WS1, WS2, WS3, and WS4 are adjacent to the vehicle tires FL, FR, RL, and RR to detect a vehicle speed by measuring the wheel speeds of related tires. The wheel speed sensor modules WS1, WS2, WS3, and WS4 include wheel speed sensors 30, 31, 32, and 33 to output voltage varying according to the rotation of tone wheels of related tires in the form of pulses.

A control module 20 controls the whole operation to control the vehicle attitude, and includes a TPMS control module 21 to detect a pressure state of the vehicle tire to inform a driver about an abnormal state and an ABS control module 22 to control the braking force of the vehicle based on a vehicle speed calculated by using wheel speeds detected through the wheel speed sensors 30, 31, 32, and 33.

The wheel speed sensors 30, 31, 32, and 33 are connected to the control module 20 through a plurality of signal cables 50, 51, 52, and 53.

The signal cables 50, 51, 52, and 53 are electrically connected to other electronic parts except for the tire pressure sensor modules 40, 41, 42, and 43. In detail, the signal cables 50, 51, 52, and 53 are installed around the tire pressure sensor modules 40, 41, 42, and 43.

The signal cables 50, 51, 52, and 53 include power lines 50a, 51a, 52a, and 53a and signal lines 50b, 51b, 52b, and 53b.

One ends of the signal lines 50b, 51b, 52b, and 53b are connected to the wheel speed sensors 30, 31, 32, and 33, and the other ends of the signal lines 50b, 51b, 52b, and 53b are connected to the ABS control module 22, so that the wheel speed sensors 30, 31, 32, and 33 can transfer pulses corresponding to the wheel speed to the ABS control module 22.

The power lines 50a, 51a, 52a, and 53a not only supply driving power to the wheel speed sensors 30, 31, 32, and 33, but also serve as communication media to transmit related tire pressures, which have been received therein from the communication sections 40-2, 41-2, 42-2, and 43-2 of the tire pressure sensor modules 40, 41, 42, and 43 through a wireless manner, to the TPMS control module 21.

Referring to FIG. 2, the TPMS control module 21 determines if the tire pressures received through the power lines 50a, 51a, 52a, and 53a are in a desirable state or an abnormal state to inform the driver about the state of the tire pressure through an alarm lamp or a display device which is not shown.

Through the power lines 50a, 51a, 52a, and 53a, all signals, which have been wirelessly transmitted from the tire pressure sensor modules 40, 41, 42, and 43, are received. The tire pressure sensor modules 40, 41, 42, and 43 wirelessly transmitting signals can be detected based on IDs contained in the signals. For example, on the assumption that a tire pressure sensor module corresponding to a sensor ID of “00” is installed at the tire FL positioned at the front-left side of the vehicle, if the sensor ID of “00” is detected from the received signal, the pressure of the tire FL positioned at the front-left side of the vehicle can be recognized through the signal that has been transmitted from the tire pressure sensor module of the tire FL.

However, the correct position of a tire pressure sensor module may not be confirmed by using only the sensor ID. For example, a tire pressure sensor module having another sensor ID instead of the sensor ID of “00” may be mounted on the tire FL positioned at the front-left side of the vehicle due to the carelessness of a user. In this case, the tire pressure sensor module actually mounted on the tire FL may be erroneously identified.

In order to recognize a related tire based on a sensor ID contained in a wirelessly transmitted signal, the positions of tire pressure sensor modules previously mounted on tires of a vehicle may be detected.

According to the embodiment, the TPMS control module 21 sequentially controls first to fourth switches 23, 24, 25, and 26, which are electrically connected to the power lines 50a, 52a, 51a, and 53a in series, one by one, and compares the intensities of received signals with each other. According to the comparison result, the TPMS control module 21 finds out the positions of the tire pressure sensor modules.

The TPMS control module 21 includes a signal intensity measuring unit 21-1, a controller 21-2, and a memory 21-3.

The first to fourth switches 23, 24, 25, and 26 series-connected to the power lines 50a, 52a, 51a, and 53a, respectively, are turned on or turned off by the controller 21-2.

The signal intensity measuring unit 21-1 measures the intensities of signals received through the power lines 50a, 51a, 52a, and 53a. The signal intensity measuring unit 21-1 may use an RSSI (Received Signal Strength Indicator) in order to measure the intensities of the received signals.

The memory 21-2 stores information used for identifying the tire pressure sensor modules 40, 41, 42, and 43.

The controller 21-2 turns on one switch at one time and measures the intensities of four received signals. The controller 21-2 compares the intensities of the four received signals with each other to find out the highest signal intensity, a related sensor ID, and a related tire. Accordingly, the positions of all tire pressure sensor modules mounted on the tires may be detected.

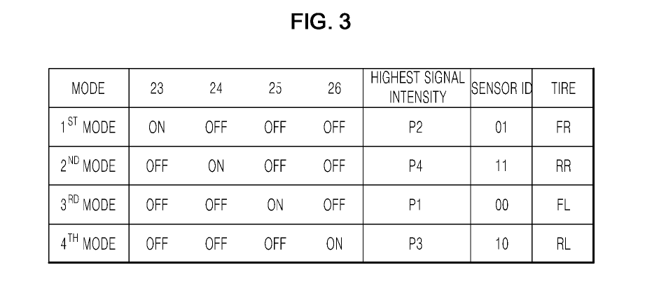

On the assumption that measured intensities of signals containing sensor IDs of “00”, “01”, “10”, and “11” are P1, P2, P3, and P4, the positions of the tire pressure sensor modules may be recognized according to the sensor IDs and the intensities of the received signals. The recognition results are represented in a table of FIG. 3.

For example, a first mode represents a case that only the first switch 23 of the power line 50a is turned on, and the second to fourth switches 24, 25, and 26 are turned off. In this case, four signals P1, P2, P2, and P4, which have been transmitted from the four tire pressure sensor modules 40, 41, 42, and 43, are received through the power line 50a. If the intensity P2 of the signal containing the sensor ID of “01” is determined as the highest signal intensity in the first mode, the tire pressure sensor module corresponding to the sensor ID of “01” may be recognized as a tire pressure sensor module mounted on the tire FR positioned at the front-right side of the vehicle. This is because the signal transmitted from the tire closest to the power line 50a represents the highest intensity.

Similarly, if the intensity P4 of the signal containing the sensor ID of “11” is determined as the highest signal intensity in a second mode, the tire pressure sensor module corresponding to the sensor ID of “11” may be recognized as a tire pressure sensor module mounted on the tire RR positioned at the rear-right side of the vehicle.

If the intensity P1 of the signal containing the sensor ID of “00” is determined as the highest signal intensity in a third mode, the tire pressure sensor module corresponding to the sensor ID of “00” may be recognized as a tire pressure sensor module mounted on the tire FL positioned at the front-left side of the vehicle.

If the intensity P3 of the signal containing the sensor ID of “10” is determined as the highest signal intensity in a fourth mode, the tire pressure sensor module corresponding to the sensor ID of “10” may be recognized as a tire pressure sensor module mounted on the tire RL positioned at the rear-left side of the vehicle.

The positions of tire pressure sensor modules detected by performing the first to fourth modes are stored in the memory 21-3. The controller 21-2 analyzes a received signal based on the positions of the tire pressure sensor modules to detect if the pressures of the tires are in a desirable state or an abnormal state and informs the driver about the pressure states of the tires.

Hereinafter, the operation of the apparatus for identifying the tire pressure sensor module according to the embodiment will be described.

After a vehicle has been started (step 101), in the case of the first mode (step 103), only the first switch 23 is turned on by the controller 21-2, so that the signal intensity measuring unit 21-1 measures the intensities of signals transmitted from all tire pressure sensor modules mounted on tires of the vehicle through the power line 50a. The measured signal intensities are transferred to the controller 21-2.

Thereafter, the controller 21-2 compares the signal intensities with each other and detects that the sensor ID contained in a signal transmitted from the tire pressure sensor module mounted on the tire FR at the front-right side of the vehicle is “01” (step 107). The detection result of the position of the tire pressure sensor module mounted on the vehicle tire in the first mode is stored in the memory 21-3 (step S109).

In the case of the second mode (step 113), only the second switch 24 is turned on by the controller 21-2, so that the signal intensity measuring unit 21-1 measures the intensities of signals transmitted from all tire pressure sensor modules mounted on tires of the vehicle through the power line 52a (step 115). The controller 21-2 compares the signal intensities with each other and detects that the sensor ID contained in a signal transmitted from the tire pressure sensor module mounted on the tire RR at the rear-right side of the vehicle is “11” (step 117). The detection result of the position of the tire pressure sensor module mounted on the vehicle tire in the second mode is stored in the memory 21-3 (step S109).

In the case of the third mode (step 119), only the third switch 25 is turned on by the controller 21-2, so that the signal intensity measuring unit 21-1 measures the intensities of signals transmitted from all tire pressure sensor modules mounted on tires of the vehicle through the power line 51a (step 121). The controller 21-2 compares the signal intensities with each other and detects that the sensor ID contained in a signal transmitted from the tire FL pressure sensor module mounted on the tire FL at the front-left side of the vehicle is “00” (step 123). The detection result of the position of the tire pressure sensor module mounted on the vehicle tire in the third mode is stored in the memory 21-3 (step S109).

In the case of the fourth mode (step 125), only the fourth switch 26 is turned on by the controller 21-2, so that the signal intensity measuring unit 21-1 measures the intensities of signals transmitted from all tire pressure sensor modules mounted on tires of the vehicle through the power line 53a (step 127). The controller 21-2 compares the signal intensities with each other and detects that the sensor ID contained in a signal transmitted from the tire pressure sensor module mounted on the tire RL provided at the rear-left side of the vehicle is “10” (step 129). The detection result of the position of the tire pressure sensor module mounted on the vehicle tire in the fourth mode is stored in the memory 21-3 (step S109).

After the first to fourth modes have been performed (step 111), the positions of the tire pressure sensor modules mounted on the vehicle tire are determined as completely detected, and the above procedure is terminated.

Although few embodiments of the disclosure have been shown and described, it would be appreciated by those skilled in the art that changes may be made in these embodiments without departing from the principles and spirit of the disclosure, the scope of which is defined in the claims and their equivalents.

What is claimed is:

1. A tire pressure sensor module identifying apparatus comprising:
a plurality of tire pressure sensor modules mounted on tires of a vehicle to wirelessly transmit pressures of the tires;
a plurality of signal cables installed corresponding to the tire pressure sensor modules and electrically connected to electrical parts except for the tire pressure sensor modules to receive signals from the tire pressure sensor modules;
a signal intensity measuring unit to measure intensities of signals received therein from the tire pressure sensor modules through at least one of the signal cables;
a plurality of switches connected between the signal cables and the signal intensity measuring unit and selectively turned on or turned off; and
a control module to turn on one of the switches, compare the intensities of the signals received from the tire pressure sensor modules through the signal cable connected to the one switch, and identify a position of the tire pressure sensor module representing a highest signal intensity based on a position of the switch.

2. The tire pressure sensor module identifying apparatus of claim 1, further comprising a memory storing an identifier of the tire pressure sensor module representing the highest signal intensity and the position of the tire pressure sensor module representing the highest signal intensity.

3. The tire pressure sensor module identifying apparatus of claim 1, wherein the signal cables comprise power lines.

4. The tire pressure sensor module identifying apparatus of claim 3, wherein each power line is used to supply power to a wheel speed sensor.

5. The tire pressure sensor module identifying apparatus of claim 1, wherein each signal cable has one end connected to a wheel speed sensor to transfer a signal of the wheel speed sensor.

6. The tire pressure sensor module identifying apparatus of claim 1, wherein the control module sequentially turns on the switches to identify positions of the tire pressure sensor modules.

7. A tire pressure sensor module identifying method comprising:
turning on one of switches of signal cables provided around a plurality of tire pressure sensor modules;
receiving and measuring signals transmitted from the tire pressure sensor modules through the signal cable connected to the switch;
comparing intensities of the measured signals of the tire pressure sensor modules with each other;
determining the tire pressure sensor module representing a highest signal intensity; and
identifying a position of the determined tire pressure sensor module based on a position of the switch.

8. The tire pressure sensor module identifying method of claim 7, wherein the receiving the signals from the tire pressure sensor modules comprises receiving identifiers of the tire pressure sensor modules.

9. The tire pressure sensor module identifying method of claim 8, further comprising storing the identifier of the tire pressure sensor module representing the highest signal intensity together with the position of the tire pressure sensor module while corresponding to the identifier.

10. The tire pressure sensor module identifying method of claim 7, further comprising previously storing information about positions of the switches of the signal cables provided around the tire pressure sensor modules.
